(19) United States
(12) Patent Application Publication
(10) Pub. No.: US 2012/0158580 A1
(43) Pub. Date: Jun. 21, 2012

(54) System, Method and Apparatus for Mobile Payments Enablement and Order Fulfillment

(76) Inventors: Antonio Claudiu Eram, Constanta (RO); Felix Daniel Crisan, Bucuresti (RO)

(21) Appl. No.: 13/331,260

(22) Filed: Dec. 20, 2011

Related U.S. Application Data
(60) Provisional application No. 61/424,879, filed on Dec. 20, 2010.

(51) Int. Cl. G06Q 40/00; G06Q 20/32

(52) U.S. Cl. 705/39

(57) ABSTRACT

A system, method and apparatus are provided for enabling mobile payments for purchases from selected merchants via a client device. A client application installed on a client device can make payments and submit shipment information when making purchases. The client application securely stores user-related payment information locally on the client device, where such information only needs to be entered once upon initialization of the client application. The client application facilitates payment transactions by forwarding user-related payment information for purchases to a payment server when authorized by a user. When making a purchase, a user can enter an identification code into the client application that identifies a product or service, where the identification code and user-related payment information are forwarded to the payment server. The payment server uses the code to retrieve details about the purchase and performs operations to complete the purchase using the received user payment-related information.

### CROSS REFERENCE TO RELATED APPLICATION(S)

This application claims priority to U.S. Provisional Patent Application Ser. No. 61/424,879, entitled “System and Method for Mobile Payments Enablement and Order Fulfillment,” filed on Dec. 20, 2010, the contents of which are incorporated herein by reference in its entirety.

### COPYRIGHT NOTICE

A portion of the disclosure of this patent document contains materials that are subject to copyright protection. The copyright owner has no objection to the facsimile reproduction by anyone of the patent document or the patent disclosure, as it appears in the Patent and Trademark Office file or records, but otherwise reserves all copyright rights whatsoever.

### TECHNICAL FIELD

The present invention relates generally to the use of a client device for enabling payments for purchased products or services and, more particularly, to a system, apparatus and method for enabling payments and order fulfillments via a mobile device.

### BACKGROUND

Currently, credit and debit cards issued by financial institutions can be normally used in order to pay for the goods and services in online or remote transactions (such those transactions occurring over e-mail, snail mail, Internet, fax, phone), where the physical credit and debit cards are located remotely from the goods and services provider and cannot be swiped by such provider. These types of remotely executed transactions (hereafter referred to as “online transactions”) are authorized by the card owner through the usage of the card number (16 digit sequence), the card expiration date and the CVC/CVV/CVV2 (Card Verification Value, Card Verification Value Code, Card Verification Code). This information is requested from the card owner to complete the transaction in order provide an added level of security that such transactions are being completed by the card owner in situations where the card is not physically present (as it is the case for online transactions). In a number of cases other information, such as the billing address, is required to be provided by the card owner as an added level of security.

Processing a transaction in a conventional environment is ultimately limited to providing the above-mentioned details to a goods and services provider, such as by providing the information telephonically or filling the information into a paper or electronic form and (in the case of Internet transactions) approving the transaction through a click of a button. This process suffers from the drawback that the user or card owner has to have the card (or its corresponding information) at hand whenever he or she is using it and has to manually provide all of the required details.

In order to cater for the comfort of the user, some services (e.g., PayPal, Moneybookers or the like) or big retailers (e.g., Amazon) overcome the need to have the card at hand by storing in the service itself (on the server-side storage) most of the details required to make the payment, where the user is only required to identify himself/herself to the service (using a username and password) and eventually enter the CVV/CVV2 code of the card. While this approach considerably eases the payment process for the user, it introduces a new layer of security risks and procedural requirements on the merchant and service side, always requiring a security certification, such as Payment Card Industry Data Security Standard9 (PCI-DSS), plus a series of security procedures to be implemented and rigidly followed on the service side.

### SUMMARY

In one or more embodiments, a method, apparatus and system are provided for enabling payments for purchases via a client device connected to a wired or wireless network, such as payments for products and services of selected merchants. In one or more embodiments, the system comprises a client device attached to a wired or wireless network for connection to a payment server. In one or more embodiments, users may install a client payment application on their client device in order to complete payment transactions, such as providing payment details and submitting shipment information when purchasing goods and services from selected merchants. In one or more embodiments, the client payment application is responsible for storing all user and payment-related information, where users only need to enter their payment, deliver and/or purchase details (e.g., credit card information, billing and shipping addresses, contact information, etc.) into the client payment application upon initialization of the client payment application and before making any purchase. In one or more embodiments, all of the user-related information saved with the client payment application is securely protected to prevent unauthorized access or use of such information.

The client payment application is executed on the device and has an interface to communicate with the payment server. In one or more embodiments, merchants have the option to define items that are available for purchase via the mobile payment client payment application and may choose to define a keyword that uniquely identifies a specific product or service available for purchase. The payment server includes a registry of all the approved merchants and all the products or services associated with a specific merchant. In one or more embodiments, the payment server is able to retrieve details about a product or service through use of the unique keyword identifier.

In one or more embodiments, upon receiving a request for payment from an approved merchant for a particular user purchase, the payment server is configured to securely communicate with the particular user's client payment application, such as over secure hyper-text transfer protocol (HTTPS) or similar secure communications, to make a request for payment. In response the client payment application will securely communicate the stored user and payment-related information to the payment server for the payment server to use in completing the purchase. In one or more embodiments, the user is provided with an opportunity to authorize and/or edit the user and payment-related information before delivering such information to the payment server. In one or more embodiments, the client payment application may initiate the payment process by securely communicating a initial request to complete a purchase from the client payment application to the payment server. The payment server may then utilize the user and payment-related information received from the client payment application to complete the purchase with the merchant.

### DRAWINGS

The above-mentioned features and objects of the present disclosure will become more apparent with reference to the following description taken in conjunction with the accompanying drawings wherein like reference numerals denote like elements and in which:

FIG. 1 is a schematic block diagram of a client device architecture in accordance with one or more embodiments of the present disclosure.

FIG. 2 illustrates an exemplary mobile client device in accordance with one or more embodiments of the present disclosure.

FIG. 3 is a schematic block diagram of a system for enabling mobile payments and the fulfillment of orders in accordance with one or more embodiments in accordance with one or more embodiments of the present disclosure.

FIG. 4 is an operational flow diagram illustrating the initialization of the client payment application by a user of the client device for enabling mobile payments and the fulfillment of orders in accordance with one or more embodiments of the present disclosure.

FIG. 5 is an operational flow diagram illustrating the “Design Time” code/word definition by the merchant in accordance with one or more embodiments.

FIG. 6 is an operational flow diagram illustrating the “Run Time” code/word definition by the merchant in accordance with one or more embodiments.

FIG. 7 is an operational flow diagram illustrating the “Run Time” code/word handling that is performed by the merchant in accordance with one or more embodiments.

FIG. 8 is a block schematic diagram of the system for enabling mobile payments and the fulfillment of orders in accordance with one or more embodiments, which further illustrates the overall payment process flow within the system.

FIG. 9 is an operational flow diagram of the method for enabling mobile payments and the fulfillment of orders in accordance with one or more embodiments.

FIG. 10 is an operational flow diagram of a method for enabling mobile payments and the fulfillment of orders in accordance with one or more embodiments.

FIG. 11 is a block schematic diagram of the system for enabling mobile payments and the fulfillment of orders in accordance with one or more embodiments of a bill payment implementation, which further illustrates the overall payment process flow within the system.

FIG. 12 is a block schematic diagram of the system for enabling mobile payments and the fulfillment of orders in accordance with one or more embodiments of a bill payment implementation in which a user may elect to process a payment using the client payment application, which further illustrates the overall payment process flow within the system.

FIG. 13 is an operational flow diagram of the system for enabling mobile payments and the fulfillment of orders in accordance with one or more embodiments in which goods/services are pushed from the merchant to user for acceptance and payment.

FIG. 14 is an operational flow diagram of the system for enabling mobile payments and the fulfillment of orders in accordance with one or more embodiments in which goods/services are pushed from the merchant to user for acceptance and payment.

FIG. 15 is an operational flow diagram of the present system, apparatus and method in which real-time advertisements are retrieved and displayed to a user upon start-up of the client payment application in accordance with one or more embodiments.

FIG. 16 is an operational flow diagram of the present system, apparatus and method in which static advertisements are retrieved and displayed to a user of the client payment application in accordance with one or more embodiments.

FIG. 17 is an operational flow diagram of the present system, apparatus and method in which goods/services are pushed from the merchant to users for acceptance and payment in accordance with one or more embodiments.

### DETAILED DESCRIPTION

In the description that follows, the various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Reference in this specification to “one embodiment”, “an embodiment”, “other embodiments”, “one or more embodiments” or the like means that a particular feature, structure, or characteristic described in connection with the embodiment is included in at least one embodiment of the disclosure. The appearances of, for example, the phrases “in one embodiment” or “in one or more embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The word “exemplary” is used herein to mean “serving as an example, instance, or illustration.” Any implementation described herein as “exemplary” is not necessarily to be construed as preferred or advantageous over other implementations.

As used herein, the term “client device” is intended to any computing device that is capable of installing a client payment application and connecting to a communication network for connection to a remote payment server. In one or more embodiments, the client device is preferably a mobile technology computing device capable of connecting to a wireless communication network, such as a laptop computer, mobile phones, cellular phones, smartphones or the like (e.g., Apple iPhone®, Google Android™, BlackBerry®, other type of PDA or smartphone), tablets (e.g., Tablet PC, iPad®, iPod Touch, etc.), or other mobile or handheld computing devices. In one or more embodiments, the client device installing the client payment application may comprise a personal computer, home computer, work station or other computing device capable of installing a client payment application. The term “client device” may be interchangeably used and referred to herein as “mobile device.”

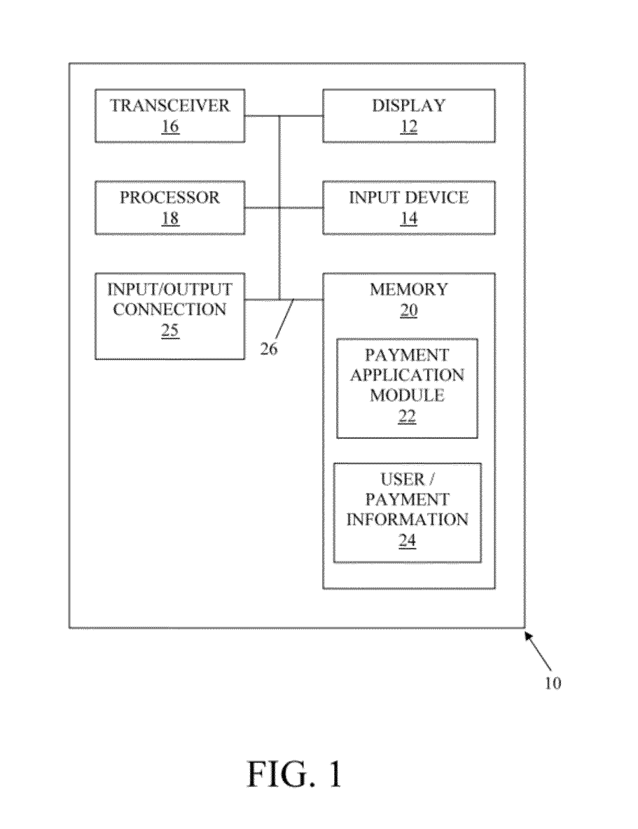

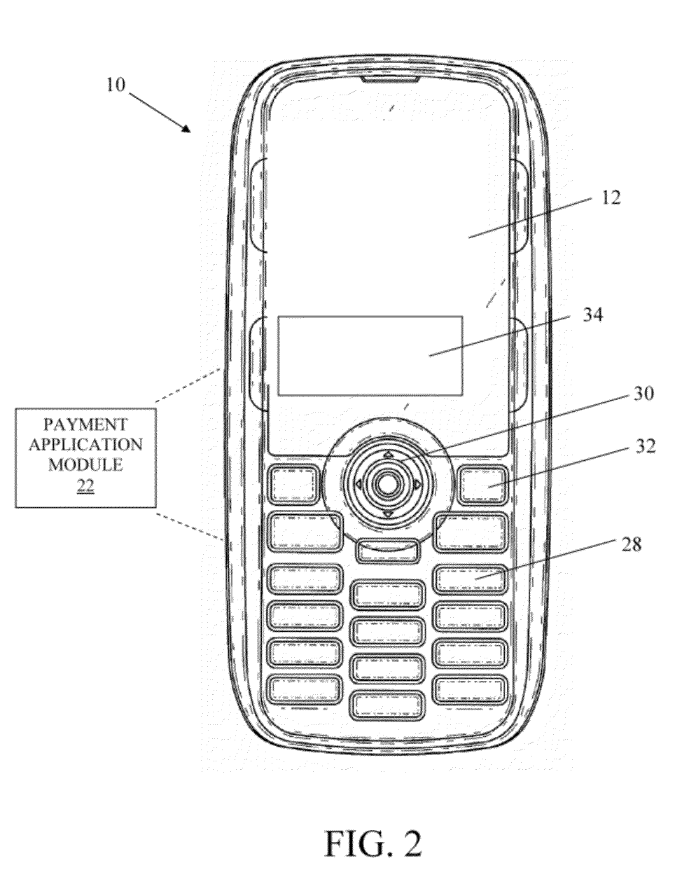

FIG. 1 is a schematic block diagram of a client device 10 in accordance with one or more embodiments of the present disclosure. In one or more embodiments, the client device 10 may include a display 12, an input device 14, a transceiver 16, a processor 18, a memory 20 and at least one input/output connection 24. In one or more embodiments, memory 20 includes a client payment application module 22 and payment and/or user information 24 stored therein. In one or more embodiments, client device 10 may comprise a mobile device including a SIM card that may be removably received within a card slot (not shown) in the client device 10. Memory 20 may include, for example, random access memory (“RAM”) or read only memory (“ROM”), while RAM may be volatile or non-volatile RAM. These various components within client device 10 are coupled to communicate data with one another, such as through an internal bus 25 or other connectors. In one exemplary embodiment, client device 10 may comprise a mobile phone, as illustrated in FIG. 2, in which display 12 may comprise a screen display and input device 14 may comprise any one or combination of a keypad 28, track ball 30, selectable buttons 32 and/or a touch screen 34 having selectable icons. The client device 10 includes an antenna coupled to transceiver 16 to facilitate the transmission and receipt of data, messages and communications over a wireless communication network by client device 10.

In one or more embodiments, software, processor-executable instructions and software architectures may be described in terms of certain software modules, such as client payment application module 22. For the purposes of this disclosure, a module is a software, hardware, or firmware (or combinations thereof) that performs or facilitates the processes, features, and/or functions described herein (with or without human interaction or augmentation). It should be understood that where a plurality of software modules are described, the functions performed by the plurality of software modules may alternatively be performed by a single software module. Similarly, where a single software module is described, the functions performed by the single software module may alternatively be performed by a plurality of software modules. Client device 10 contains embedded software including modules, programs, processor-executable instructions and/or data stored internally in memory 20.

In one or more embodiments, the client payment application module 22 installed on the client device 10 introduces a solution that combines the ease-of-use advantages for a user associated with storing payment and/or user information 24 within the client device 10 while leaving the security control entirely in the user's hands by storing sensitive payment and/or user information 24 within the client device 10 under the control of the user instead of a remote server under the control of some third party.

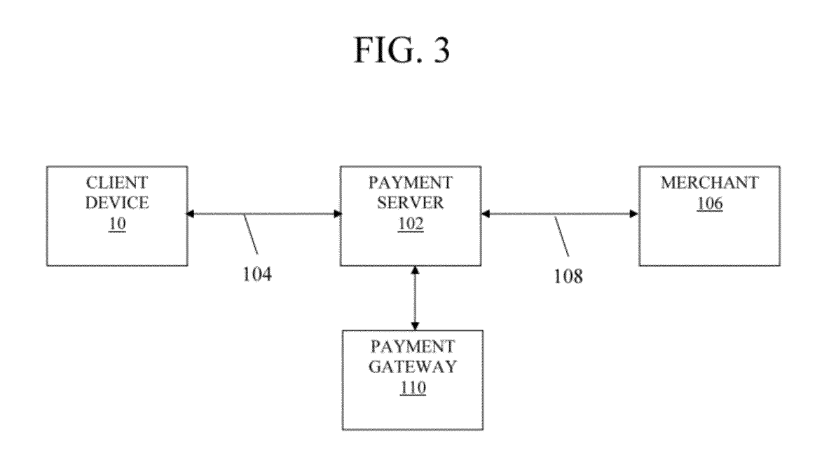

In one or more embodiments, a system, apparatus and method are provided for enabling mobile payments and the fulfillment of orders associated with such payments through use of the client payment application module 22 installed on the client device 10 and the payment and/or user information 24 stored on the client device 10. The system, apparatus and method of the present disclosure provide mobile payment enablement that can be used to pay for goods and services from select merchants 106 using a client device 10 connected to a wired or wireless network 104 in order to communicate with a remote payment server 102, as illustrated by the system 100 shown in FIG. 3. The payment server 102 is similarly connected to one or more merchants 106 through a wired or wireless network 108 and also to a payment gateway 110 to complete payment transactions using the user's payment information 24. In one or more embodiments, the system 100 may be utilized as an order fulfillment system for fulfilling orders associated with mobile payments. This system 100 allows an end user of client device 10 to immediately place orders for good and/or services while providing the merchant 106 with all the required payment and/or user information 24 for the order fulfillment. This information 24 may include user or buyer information, such as the name, email, phone and billing or delivery address of the buyer. Upon successful authorization of a payment through the payment gateway 110, the components of the system immediately notify the merchant 106 about the transaction, providing all the details for order fulfillment and shipment of the goods and/or services ordered.

In one or more embodiments, the system 100 includes at least two components—the client payment application (payment application 22) residing on a user's mobile device 10 and a server component (payment server 102). The client payment application 22 is responsible for storing all the user and payment-related information 24: including but not limited to credit or debit card information (e.g., card number or PAN—Personal Account Number) or a general bank account number not necessarily associated with a credit and/or debit card. In case the payment instrument is a credit/debit card, the expiration date of the card, the name on card, the security code (e.g., CVV/2 code), and billing address should be provided. In the case where the payment instrument is a generic bank account number, additional information (such as an account password or other authentication data) may be required. In one or more embodiments, further to the payment information, contact information—including but not limited to at least one shipping address and contact information (e.g., phone number and/or email) are stored with the user and payment-related information 24. The server component (payment server 102) acts as a payment gateway.

In one or more embodiments, all the user-related information 24 saved with the client payment application 22 is securely protected to prevent unauthorized access or use of such information. For example, the user-related information 24 may be protected by a security code (e.g., a Personal Identification Number—PIN) that must be entered to gain access to the information and/or the information is only stored on the mobile device in an encrypted manner, encrypted with a key that is dependent on the client device 10, such that copying the user-related information 24 to another device will make it impossible to decrypt and access. In one or more embodiments, the security code might be used only to gain access to a key that will be used to retrieve a key-pair from the server component 102 and this key pair to be actually used for gaining access to the payment and user information 24.

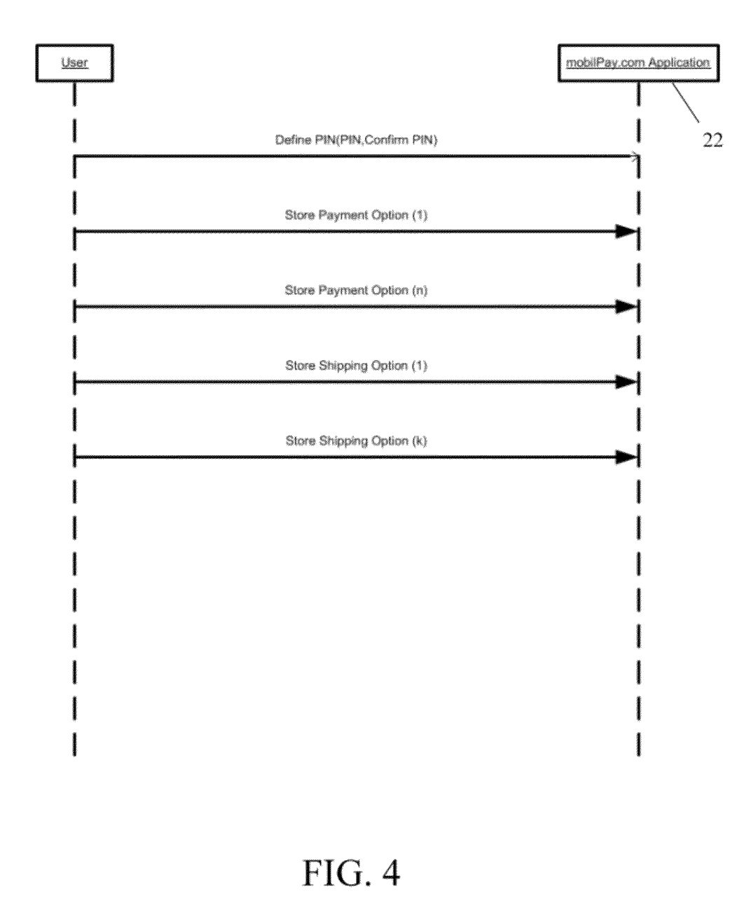

Referring now to FIG. 4, an operational flow diagram illustrating the initialization of the client payment application 22 by a user on the client device 10 is illustrated in accordance with one or more embodiments. In the example of FIG. 4, the client payment application 22 is a “mobilPay.com Application” that may be downloaded or otherwise installed on the client device 10. In one or more embodiments, upon initialization of the client payment application 22, the user is initially prompted to either define a new security code or enter a previously established security code. After the security code has been defined and/or verified, the client payment application 22 allows a user to enter one or more payment options (e.g., payment option (1) . . . payment option (n)) by collecting payment information for the various payment options from the user and storing the collected payment information with payment and user information 24 in memory 20 as described herein. In one or more embodiments, the client payment application further allows a user to enter one or more shipping options (e.g., shipping option (1) . . . shipping option (k)) by collecting shipping information for the various shipping options from the user and storing the collected shipping information with payment and user information 24 in memory 20 as described herein.

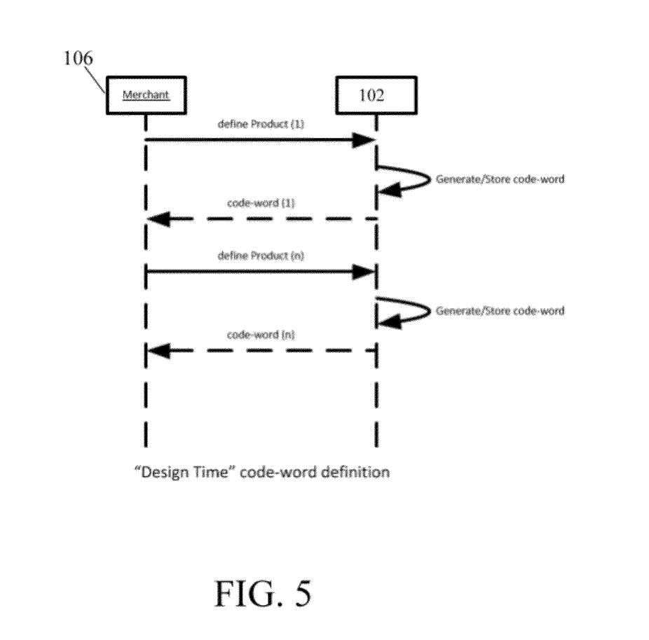

In one or more embodiments, the payment server 102 component has a registry of all the approved merchants 106 and all of the products and/or services associated with a specific merchant 106. The merchant 106 is able to communicate details about a product or service (e.g., description, price, currency, merchant) to be purchased based on a product identification code, such as a word (e.g., ‘PHONE’ or ‘LAPTOP’), a code (e.g., ‘453211’ or ‘ef634jk’), a symbol, an image or any identification. In one or more embodiments, each product identification code may uniquely identify a product or service, where each product identification code can be either generated by the payment server 102 or can be specified by the merchant 106. Assigning a product identification code can take place when the merchant 106 is defining the product in the system platform, as illustrated in the operational flow diagram of FIG. 5 illustrating a “Design Time” product identification code definition by the merchant 106 in accordance with one or more embodiments. In the operational flow diagram of FIG. 5, the merchant 106 provides the payment server 102 with details regarding a product to be stored in the payment server 102 and a product identification code is generated for the particular product and stored in the payment server 102, where either the merchant 106 or the payment server can generate the product identification code associated with a particular product. Product and associated product identification code pairs can be generated for one or more (e.g., 1 . . . n, where n>1) products. In one or more embodiments, the payment server 102 is programmed to allow merchants 106 to define specific product identification codes or propose product identification codes that are automatically generated.

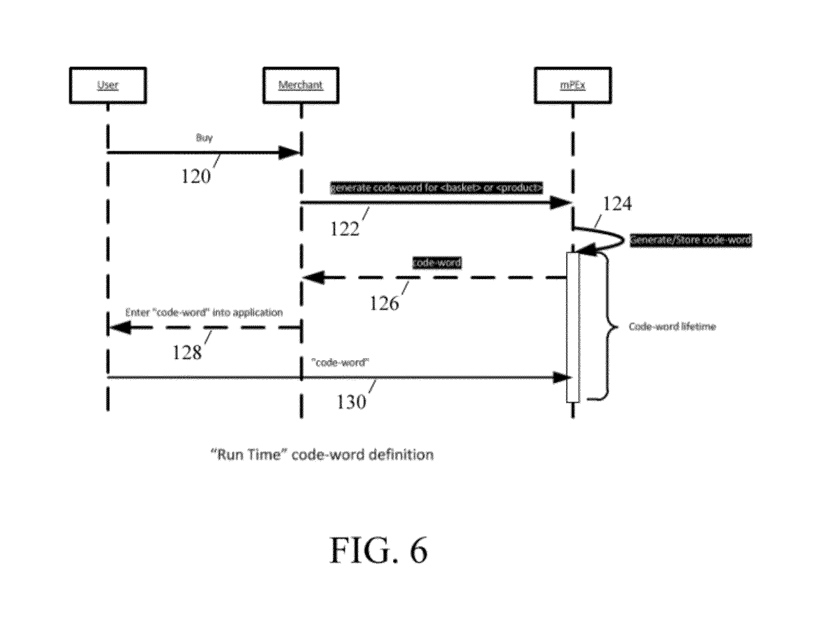

In one or more embodiments, a product identification code associated with a particular product does not have to be predefined but can be generated at the time of purchase, as illustrated in FIG. 6 in an operational flow diagram illustrating the “Run Time” product identification code definition by the merchant 106 in accordance with one or more embodiments. When a user attempts to make a purchase from a merchant 106 in operation 120, the merchant communicates the details of the purchase to the payment server 102 in operation 122, whereupon a product identification code is generated for the particular purchase and stored in the payment server 102 in operation 124. The product identification code generated for the product or service being purchased is returned to the merchant 106 in operation 126. The merchant may then communicate the product identification code generated for the product or service being purchased to the user for the user to then enter the product identification code into the client payment application 22 in operation 128. The client payment application will then communicate the product identification code to the payment server 102 in operation 130 along with the payment and user information 24 to complete the payment transaction, where the payment server 102 can identify the product or service being purchased according to the associated product identification code stored in the payment server 102 for such product or service. In one or more embodiments, the product identification code may only be temporarily assigned to a product or service and may have a lifetime that expires upon completion of the purchase.

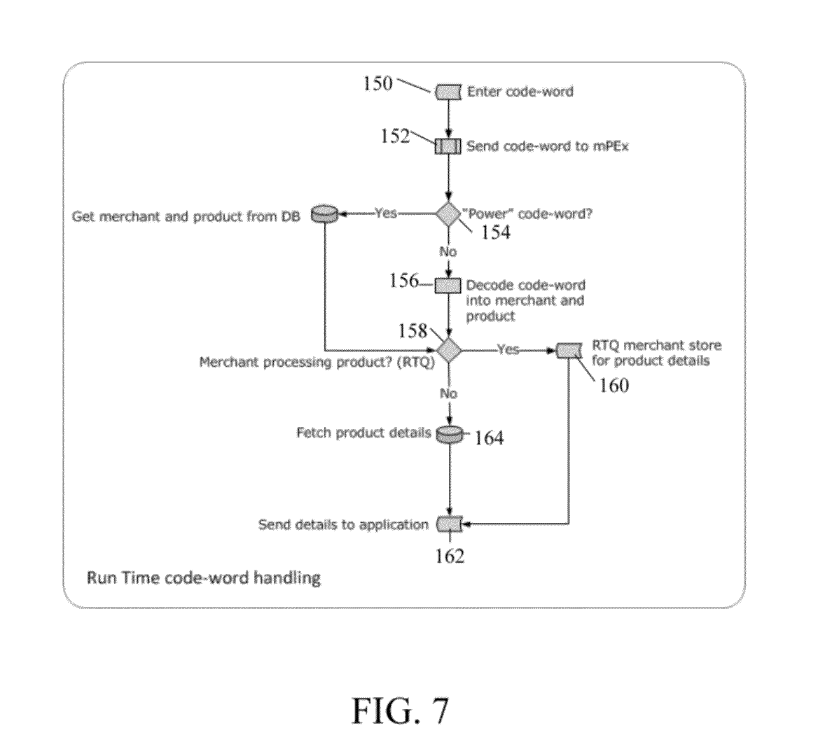

Referring now to FIG. 7, an operational flow diagram illustrating the “Run Time” product identification code handling that is performed by the payment server 102 in accordance with one or more embodiments is illustrated. After a user activates the client payment application 22 installed on their client device 10, the user may enter a specific product identification code in operation 150 for an associated product or service to purchase. In operation 152, the client payment application 22 will cause the client device 10 to send the entered product identification code to the payment server 102. Upon receiving a request with the product identification code from the client device 10 (as sent by a client payment application 22), the payment server 102 will try to determine the product and the merchant selling the product associated with the product identification code that the user entered. In order to accomplish this task, the payment server 102 will initially determine in operation 154 whether the product identification code is contained in a pre-defined dictionary database (e.g., a database of normally meaningful words or “power” words—such as ‘LAPTOP’ or ‘TVSET’ or ‘GAME’). If the product identification code is not found in the pre-defined dictionary database of certain meaningful words, the product identification code will be assumed to be a regular code (normally meaningless words or codes, such as ‘1k7hh’ or ‘jhyyg7eoo3’) and the payment server 102 will attempt to decode the product identification code in operation 156, such as through a binary decomposition, into a merchant id, product type and product type. Once the product type is determined, the payment server 102 may determine in operation 158 whether the product identification code requires a RealTimeQuote (or RealTimeQuery—RTQ) from the merchant 106. If so, a request will be made to the merchant 106 in operation 160 requesting details about the product availability, attributes, pricing or other information. The details returned from the merchant 106 will then be sent to the client payment application 22 by the payment server 102 in operation 162. If a RealTimeQuote was not required, the product details (e.g., availability, attributes, pricing or other information) stored in a database accessible by the payment server 102 are retrieved in operation 164 and then sent to the client payment application 22 by the payment server 102 in operation 162.

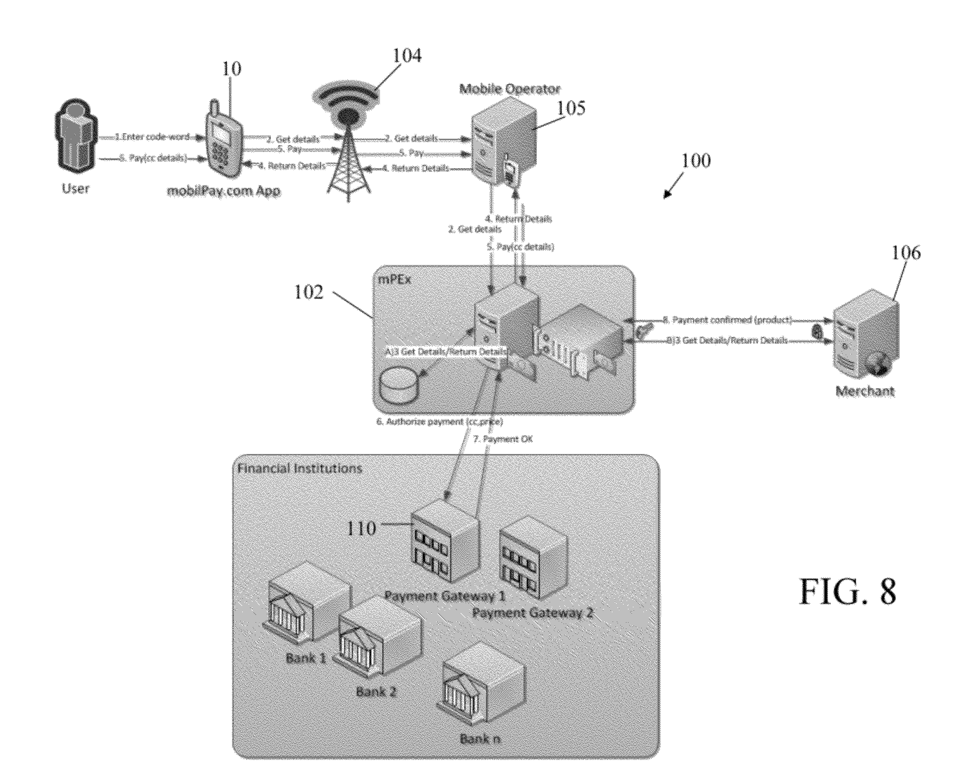

Referring now to FIG. 8, a block schematic diagram of the system 100 for enabling mobile payments and the fulfillment of orders is illustrated in accordance with one or more embodiments to further illustrate the overall payment process flow within the system 100. In one or more embodiments, a user may activate the client payment application 22 installed on their client device 10 and enter a specific product identification code in operation 201 for an associated product or service to purchase. In operation 202, the client payment application 22 will obtain the details for the product or service being purchased by communicating a request to “get details” associated with the entered product identification code to the payment server 102, such as by communicating the request through a wireless network 104 and mobile operator 105. The payment server 102 will then retrieve the details for the product or service associated with the received product identification code in operation 203 by either retrieving predefined details for the product or service that were previously defined and stored in a database at the payment server 102 in operation 203A or by communicating a request for such details to the merchant 106 in operation 203B. If a request is communicated to the merchant 106, the merchant 106 will issue a response communication with the requested details for the associated product or service, which the payment server 102 will then store in the database at the payment server 102 as part of operation 203B.

The details for the product or service associated with the product identification code input by the user are then returned to the client device 10 in operation 204. The client payment application 22 may then cause the details to be displayed on the client device 10 for the user to view. The client payment application 22 then allows the user to elect to pay for the product or service in operation 205 if the details are acceptable to the user. The client payment application then communicates the payment and user information 24 stored in the client device 10 over the network 104 the payment server 102 as part of operation 205 with instructions to pay for the product or service associated with the input product identification code. The payment server 102 will then utilize the payment and user information 24 received from the client device 10 to authorize the payment transaction in operation 206, such as by communicating the payment and user information 24 to a payment gateway 110 associated with elected type of payment (e.g., payment gateway for a particular bank for the user's bank account or credit card). Upon approval of the payment, the payment server 102 will receive an approval or authorization from the payment gateway 110 in operation 207. The payment server 102 will then communicate confirmation that payment has been completed to the merchant 106 in operation 208 along with the payment and user information 24 required to complete the purchase (e.g., a shipping address selected from the client payment application 22). The merchant 106 may then complete the purchase.

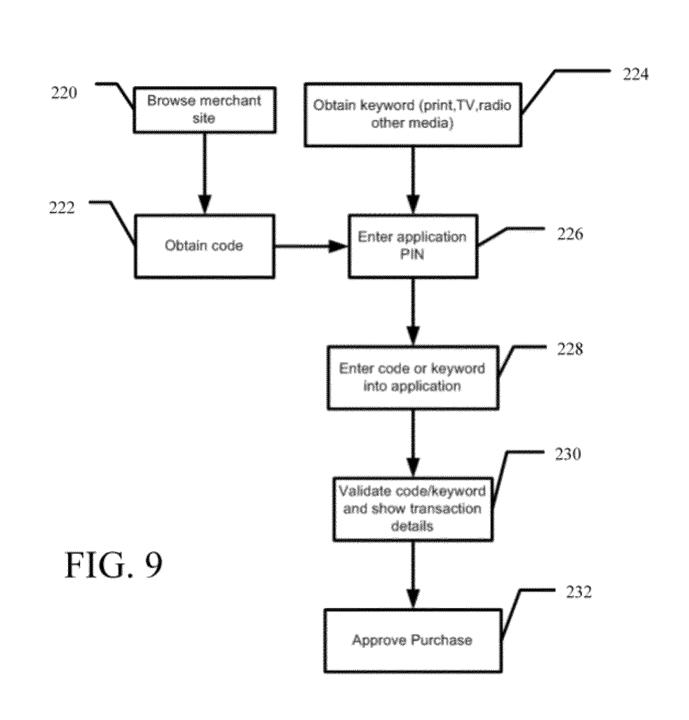

Referring now to FIG. 9, an operational flow diagram of a method for enabling mobile payments and the fulfillment of orders in accordance with one or more embodiments is illustrated. In operation 220, a user may visit an online website or actual store of a merchant 106 to view products or services available for purchase. Upon identifying a product or service that the user wishes to purchase, the user may then obtain a product identification code associated with the product or service to be purchased in operation 222. Alternatively, a user may obtain the product identification code associated with the product or service to be purchased from a source of advertising (e.g., print media, television, radio, electronic media or other media) in operation 224. After a user has obtained a product identification code associated with a product or service the user wishes to purchase, the user then activates the client payment application 22 on the user's client device 10, where the client payment application prompts the user to input a security code (e.g., PIN) in operation 226 in order to access the client payment application 22. Upon successful receipt of the security code, the client payment application will further prompt the user to enter the product identification code associated with a product or service the user wishes to purchase in operation 228. The product identification code is then validated with the payment server 102 as described herein with the details of the transaction being returned to the client payment application 22 in operation 230 for display to the user. The client payment application 22 will then provide the user with the opportunity to approve the purchase in operation 232 upon acceptance of the transaction details, where payment information 24 will then be communicated to the payment server 102 to complete the transaction is approved.

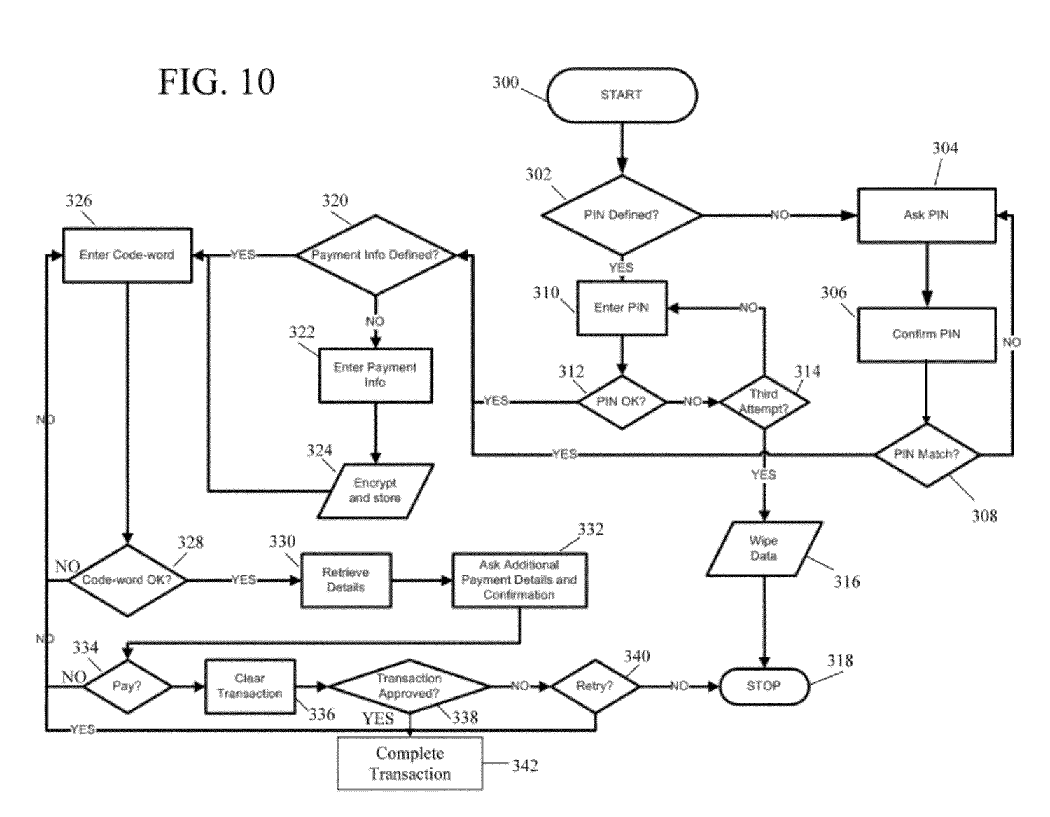

Referring now to FIG. 10, a detailed operational flow diagram of a method for enabling mobile payments and the fulfillment of orders in accordance with one or more embodiments is illustrated. After activation of the client payment application 22 in operation 300, the client payment application 22 determines whether a security code (e.g. PIN) has previously been defined in operation 302. If a security code has not previously been defined, the client payment application 22 prompts the user to input a security code in operation 304. The client payment application then confirms the security code by requiring the user to again input the security code in operation 306. If it is determined in operation 308 that both input security codes match, the security code is confirmed and operation of the client payment application 22 continues. If it is determined in operation 308 that both input security codes do not match, the client payment application 22 returns to operation 304 and requests that the user input a new security code.

If a security code had previously been defined, the client payment application 22 prompts the user to input the security code in operation 310. The client payment application 22 determines in operation 312 whether the input security code matches the previously defined stored security code that is stored in memory 20. If it is determined in operation 312 that the input security code match the previously defined stored security code, operation of the client payment application 22 continues. If the input security code does not match the previously defined stored security code, the client payment application 22 determines in operation 314 whether there have been a predetermined number of attempts to enter a correct security code (e.g. three attempts). The client payment application 22 allows a user to attempt to enter the correct security code up until the predetermined number of attempts. After the number of attempts to enter a security code equals the predetermined number of attempts allowed, the client payment application 22 takes an appropriate security measure in operation 316 and ceases operation of the client payment application 22 in operation 318. In one or more embodiments, the client payment application 22 can be programmed to prevent access to the user-input stored information 24 if there are a certain number of failed attempts to enter the security code, so as to guard against the situation where the client device 10 is stolen. For example, entering the PIN wrong for a number of attempts (e.g., three times) on the launch of the client payment application 22 will cause the client payment application 22 be become locked or may delete all the user's information 24 stored on the client device 10 as part of the security measures taken in operation 316. In one or more embodiments, the client payment application 22 is programmed to prompt the user on the first run to define a user-input security code (e.g., a PIN or password). On the subsequent runs of the client payment application, the user is required to enter the previously defined security code before using the client payment application.

In one or more embodiments, after a user input security code grants access to the client payment application 22, a determination is made in operation 320 whether payment and user information 24 has previously been defined by the user and stored in memory 20 of client device 10. If not previously defined, the client payment application 22 prompts the user to input payment and user information 24 in operation 322. In one or more embodiments, the client payment application 22 is programmed to request from the user and store various types of information required to complete a mobile purchase transaction, such as the details of the user's credit or debit card(s) or account information associated with another type of payment account, the user's billing address, one or more preferred shipping addresses, the user's contact information (e.g., email address, phone numbers, etc.) and/or other types of user-related information (e.g., personal security questions and answers). The address details that are requested and stored would be required for the order fulfillment. The email address and/or phone number of the user that are requested and stored could be used for confirmation of the order by the merchant 106 or for sending notifications about the order status.

In one or more embodiments, the input payment and user information 24 is encrypted and stored in the memory 20 of client device 10 in operation 324. For example, payment and user information 24 may be encrypted with a key that is dependent on the client device 10, such that copying the payment and user information 24 to another device will make it impossible to decrypt and access.

After payment and user information 24 is stored in client device 10, the client payment application 22 prompts the user in operation 326 to enter a product identification code associated with product or service the user wishes to purchase, where the product identification code is an identification that is jointly agreed by the merchant 106 and the payment server 102 (or simply identified by one of these components). The client payment application 22 is programmed to communicate the input code-word to the payment server 102, where the payment server 102 determines in operation 328 whether the received product identification code corresponds to a valid code-word (e.g., by verifying the received product identification code against those stored in a database at the payment server 102 or by verifying the received product identification code with the merchant 106). If the received product identification code corresponds to a valid product identification code, the details for the product or service associated with the received product identification code are retrieved in operation 330 by the payment sever 102. The payment server 102 delivers the retrieved details for the product or service to be purchased to the client payment application 22 for confirmation for payment in operation 332. As part of operation 332, the payment server 102 may further request additional payment or user information that may be required.

In one or more embodiments, the client payment application 22 then prompts a user with the retrieved details and provide the user with the ability to complete payment using an appropriate input on the client device 10 in operation 334. If payment is elected, the client payment application communicates the payment request along with payment and user information 24 to payment server 102. In one or more embodiments, the client payment application 22 is also programmed to send information previously input by the user and stored on the client device 10 to the server component as necessary to complete the purchase, such as the details of the card, the details of the shipping address, email address and phone, and also to receive a status of the payment (i.e., whether or not payment was successfully accepted) and an acknowledgement of the fact that the product will be shipped or the services will be delivered.

In one or more embodiments, the payment server 102 performs attempts to clear the payment transaction in operation 336, such as by communicating payment information to the payment gateway 110. The payment server 102 is programmed to receive from the client payment application 22 the details of the user (e.g., such as the e-mail and phone number, shipping address and credit/debit card details) and initiate a transaction with a clearance house through payment gateway 110 in order for the actual money to be withdrawn from the user's card account (or another account) and transferred to the merchant account (eventually after a pre-defined period). The payment server 102 is also programmed to display in real-time information about the transactions that have been performed and to filter these transactions based on their state, the user that has initiated the transaction, or a specific period of time.

In one or more embodiments, if the transaction is not approved by the payment server 102 in operation 338, then payment server 102 may determine in operation 340 whether the transaction should be attempted again. If no further attempts are to be made, then operation of the client payment application 22 ceases in operation 318. If further attempts are to be made, the operation of the client payment application 22 returns to operation 326 where the user is again prompted to enter a product identification code for a product or service to be purchased. If the transaction is approved by the payment server 102 in operation 338, the purchase is completed in operation 342 by notifying the merchant 106 of the completed transaction.

In one or more embodiments, the client device 10 executes the client payment application 22 that saves the user details onto the client device 10 and communicates with the other components, most notably the payment server 102, using the standard data connection available on the client device 10. In one or more embodiments, the communication between the client payment application 22 and the payment server 102 takes place securely, such as over secure hyper-text transfer protocol (HTTPS), proprietary protocol based on eXtensible Markup Language (XML) or similar secure communications. In one or more embodiments, in order to implement the functionality of the present system, apparatus and method, the payment server 102 must be configured to receive communication from the client payment application 22 operating on the client device 10 and to sends back relevant information based on the type of information requested or action required to be taken.

In one or more embodiments, before the payment server 102 is capable of processing any request from the client payment application 22, the payment server 102 needs to have defined (a) one or more merchants 106 (b) one or more products with each product belonging to a specific merchant 106, and (c) a unique product identification code attached to each product. In the case there are multiple merchants 106 offering the exact same product, the payment server 102 is able to distinguish between merchants 106 based on these unique product identification codes. In some embodiments, each of the product identification codes will have a validity period associated with their use. Once the validity period exceeds the requests for products/services identified by the respective product identification code, use of such an expired product identification codes will result in an error message and a failed transaction.

In one or more embodiments, the payment server 102 allows merchants 106 to define different types of products/services associated with corresponding product identification codes, such as ones that include a physical delivery of products/services and the ones for which the delivery (and hence the complete order fulfillment) is electronic (e.g. licenses, access to online services, etc).

In one or more embodiments, upon entering a product identification code into the client payment application 22, the product identification code is transmitted to the payment server 102, where the payment server 102 is queried about the details of the service or product associated with the product identification code. In the response sent to the client payment application 22, the payment server 102 will also specify if the product associated with the product identification code will or will not require physical delivery. If physical delivery is required, the payment server 102 will send back an indication for the client payment application 22 to provide the shipping address together with the details for the confirmation of the payment. If electronic delivery is required, the payment server 102 may send back an indication for the client payment application 22 to provide an email address (e.g., for email delivery) or phone number (e.g., for SMS or MMS delivery) with the details for the confirmation of the payment. In any case (i.e., whether physical delivery is required or not), the payment server 102 returns details about the vendor and product identified from the associated product identification code, including such information as product description and price. The user is then presented by the client payment application 22 with the details of the transaction and, if physical delivery is required, may be presented with the ability to make a selection from the list of previously-defined shipping addresses stored on the device, where the selected shipping address details are then sent to the payment server 102 along with the confirmation of the purchase.

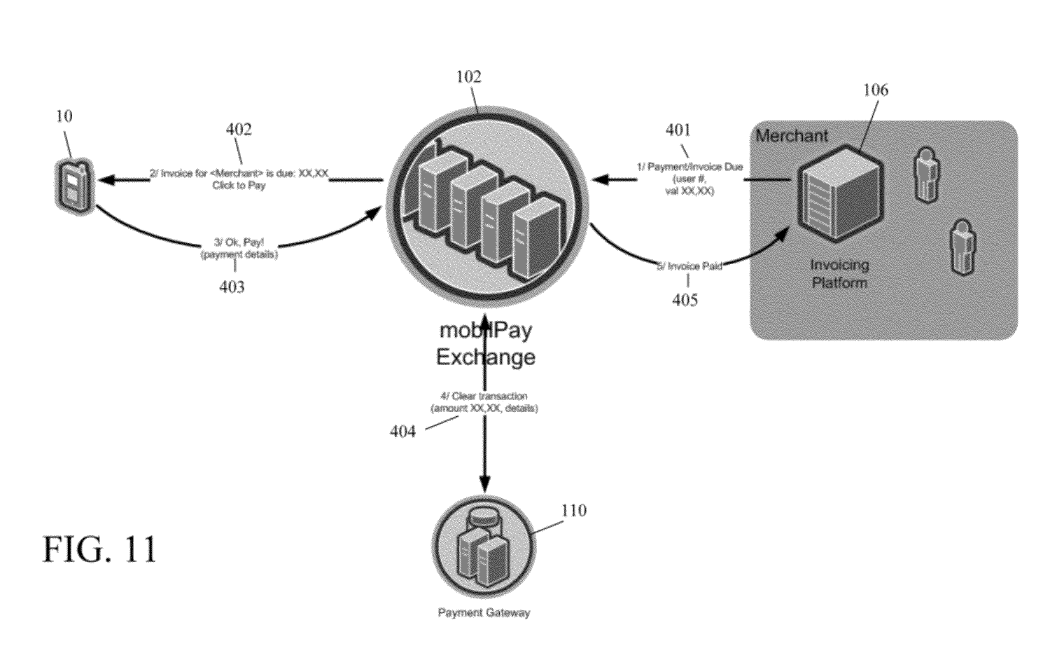

Referring now to FIGS. 11-16, a number of operational flow diagrams are illustrated for various embodiments of different implementations of the present system, apparatus and method in accordance with one or more embodiments. FIG. 11 illustrates a bill payment implementation in which the present system, apparatus and method can be utilized to process bills, invoices or payments from merchants 106 in accordance with one or more embodiments. The merchant 106 communicates an invoice or request for payment in operation 401 with the details of a particular transaction to the payment server 102. A product identification code for the particular transaction may be generated and stored at the payment server 102. In operation 402, the transaction details are communicated to the client payment application 22 on the client device 10. Upon receiving an indication from the user to pay for the transaction, the client payment application 22 communicates the payment and user information 24 to the payment server 102 in operation 403. The payment server 102 then clears the transaction in operation 404 through the appropriate payment gateway 110 associated with the form of payment. Upon receiving clearance of the payment transaction from the payment gateway 110, the payment server 102 then communicates to the merchant 106 that the invoice has been paid.

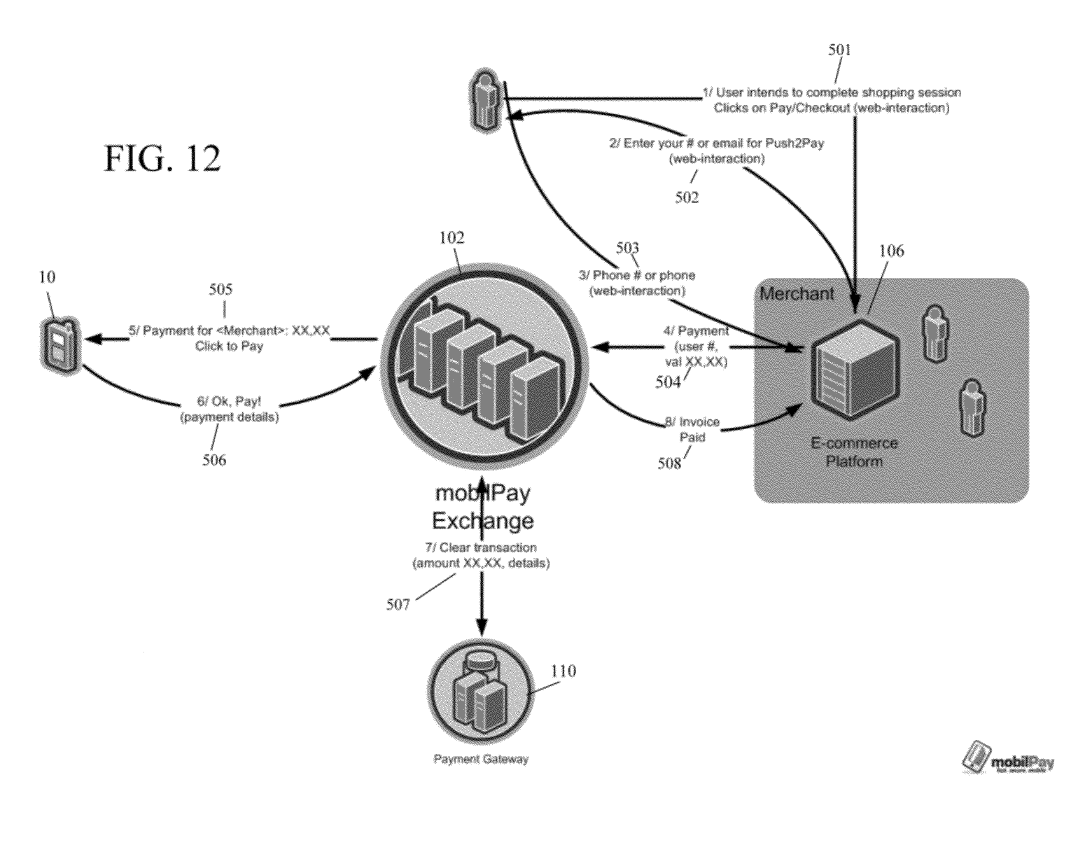

FIG. 12 illustrates a bill payment implementation in which the present system, apparatus and method can be utilized in which a user may elect to process a payment from a merchant 106 in accordance with one or more embodiments. For example, when making a purchase with a particular merchant 106 (e.g., whether on the website or in the actual store of the merchant 106 or over the phone), a user may be provided with an option to pay for a product or service using their client payment application 22 in operation 501. In one embodiment, the option of using the user's client payment application 22 is referred to as “Push2 Pay.” Upon selection of this option, the merchant 106 (e.g., through their e-commerce platform or IVR) prompts a user to enter contact information that allows the user's client device 10 be communicated with in operation 502, such as by requesting the user's phone number or email address, where such contact information is returned to the merchant 106 from the user in operation 503 (e.g., through web interaction or otherwise). The merchant 106 communicates an invoice or request for payment in operation 504 with the details of a particular transaction to the payment server 102, including the contact information for the user provided in operation 502 or otherwise during the transaction process. A product identification code for the particular transaction may be generated and stored at the payment server 102 at this time or may previously have been established by one or more of the components of FIG. 12. In operation 505, the transaction details are communicated to the client payment application 22 on the client device 10. Upon receiving an indication from the user to pay for the transaction, the client payment application 22 communicates this request along with the payment and user information 24 to the payment server 102 in operation 506. The payment server 102 then clears the transaction in operation 507 through the appropriate payment gateway 110 associated with the form of payment. Upon receiving clearance of the payment transaction from the payment gateway 110, the payment server 102 then communicates to the merchant 106 that the invoice has been paid in operation 508.

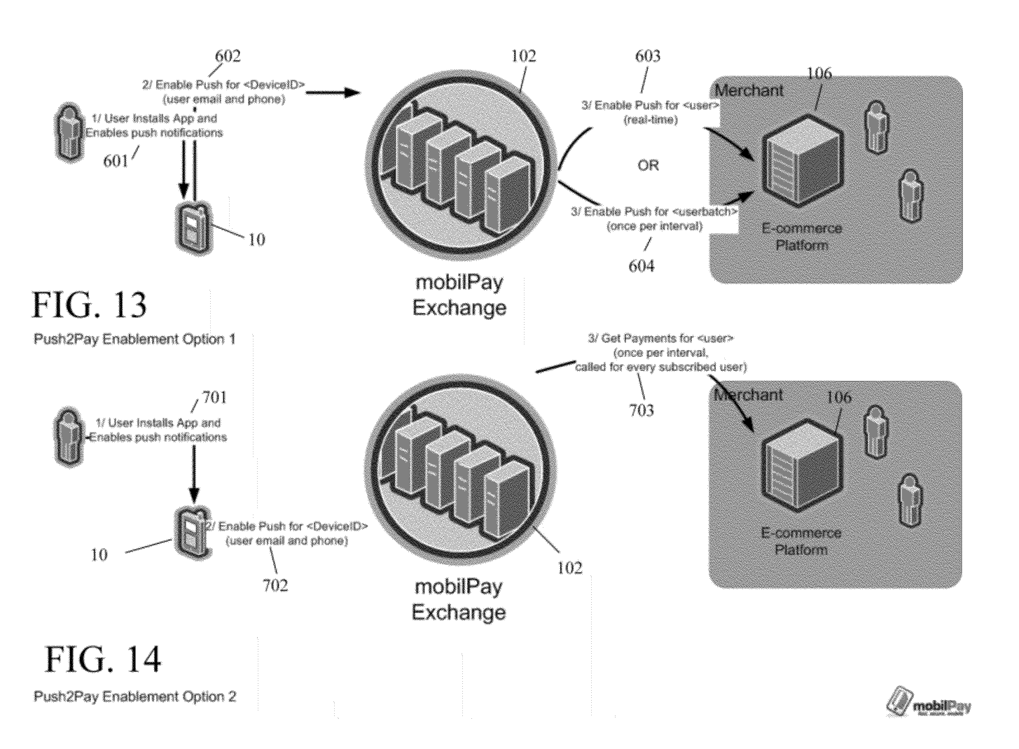

FIG. 13 illustrates a Push2 Pay enablement implementation in which the present system, apparatus and method can be utilized to allow recurrent bill payment for utility providers (or any other merchants 106 in which there is a merchant issued bill at various intervals) in accordance with one or more embodiments. In this implementation, the client payment application 22 installed on the user device 10 is configured to allow a user to select a ‘subscription’ to a merchant 106 platform. After a user activates the client payment application 22 installed on their client device 10, the user may enable push notifications in operation 601 to establish a ‘subscription’ to the merchant 106 platform, thereby notifying the server components that whenever a new payment event is issued (or when the payment is due) for the respective subscriber/user, the system platform can send a push2pay notification to the user's client payment application 22 alerting the user to pay immediately. In operation 602, the client application 22, upon receiving the user selection, communicates a request to the payment server 102, along with identifying information about the client device 10 and/or user, to send a push2pay notification to the user's client payment application 22 whenever a new payment event is issued (or when the payment is due). This notification may then be sent to one or more merchants 106 in real-time (in operation 603) or upon scheduled push notifications to merchants 106 at certain intervals (in operation 604).

FIG. 14 illustrates another Push2 Pay enablement implementation in which the present system, apparatus and method can be utilized as an alternative (to the embodiment described in connection with FIG. 13) subscription method to allow recurrent bill payment for utility providers (or any other merchants 106 in which there is a merchant issued bill at various intervals) in accordance with one or more embodiments. In this implementation, the client payment application 22 installed on the user device 10 performs a ‘subscription’ to the merchant platform, notifying the server components that whenever a new payment event is issued (or when the payment is due) for the respective subscriber, the platform can send a push2pay notification alerting the user to pay immediately. In this implementation, the client payment application 22 installed on the user device 10 is configured to allow a user to select a ‘subscription’ to a merchant 106 platform. After a user activates the client payment application 22 installed on their client device 10, the user may enable push notifications in operation 701 to establish a ‘subscription’ to the merchant 106 platform, thereby notifying the server components that whenever a new payment event is issued (or when the payment is due) for the respective subscriber/user, the system platform can send a push2pay notification to the user's client payment application 22 alerting the user to pay immediately. In operation 702, the client application 22, upon receiving the user selection, communicates a request to the payment server 102, along with identifying information about the client device 10 and/or user, to send a push2pay notification to the user's client payment application 22 whenever a new payment event is issued (or when the payment is due). The payment server 102 may then get payment for a merchant 106 for the particular user in operation 703.

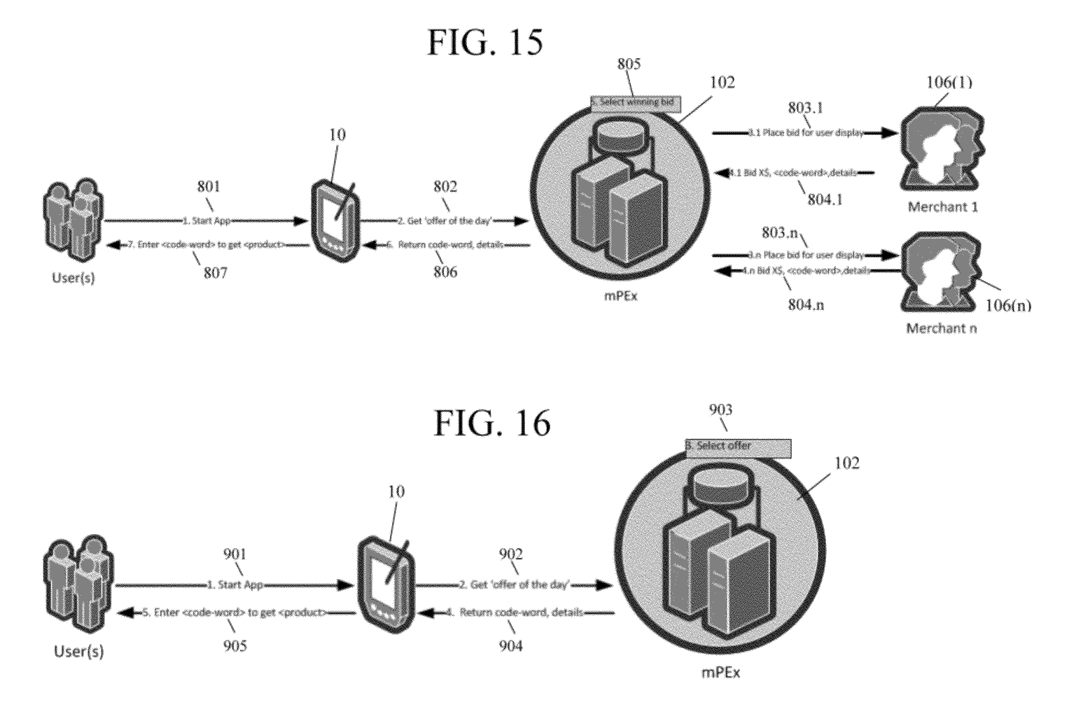

FIG. 15 illustrates a bill payment implementation in which the present system, apparatus and method can be utilized in which real-time advertisements are retrieved and displayed to a user upon start-up of the client payment application 22 in accordance with one or more embodiments. Upon activation of the client payment application 22 on the client device 10 in operation 801, the client payment application 22 communicates a request in operation 802 to the payment server 102 to retrieve real-time advertisements from merchants 106 (e.g., client payment application 22 places a request to get the “offer of the day”). In one or more embodiments, these advertisements may relate to a product or service that is possibly being sold at a discount with the option of purchasing such product or service being provided to a user by the client payment application 22 (e.g., such as through a single press of a button/banner presented on the home screen of the client payment application 22 on a display of the client device 10). In one or more embodiments, in deciding what product or service will be presented to a particular user, the payment server 102 can ask for ‘bids’ in operation 803 from a plurality of merchants 106 (e.g., up to n merchants 106) enrolled in the platform. In one or more embodiments, the payment server 102 may provide some context related to the user (e.g., the location where the request is being made from, purchase history of the user, demographics of the user, whether the respective user has previously purchased anything from the respective merchant, etc.). In operations 804.1 to 804.n, the “n” number of merchants 106 can return bids with certain product details. In operation 805, the payment server may select one or more winning ‘bids’ based on a series of preconfigured parameters (for instance, the merchant bidder willing to pay the biggest processing fee, etc.). In operation 806, the winning bid is communicated to the user's the client payment application 22 for display of the client device 10, where the winning bid will include information about the product or service that the user can purchase along with its corresponding product identification code. In operation 807, the user may enter the product identification code in order to purchase the product or service, where the purchase will then be completed as described in the various embodiments herein.

FIG. 16 illustrates a bill payment implementation in which the present system, apparatus and method can be utilized in which static advertisements are retrieved and displayed to a user upon start-up of the client payment application 22 in accordance with one or more embodiments. Upon activation of the client payment application 22 on the client device 10 in operation 901, the client payment application 22 communicates a request in operation 902 to the payment server 102 to retrieve static advertisements from merchants 106 (e.g., client payment application 22 places a request to get the “offer of the day”). The request for static advertisements from the client payment application 22 may comprise a selectable input or prompt that the client payment application 22 receives from the user or the client payment application may automatically request such advertisements upon activation. In one or more embodiments, the payment server 102 contains a listing of one or more static advertisements (e.g., purchase offers) it has received from merchants 106 and stored in a database at the payment server 102. In operation 903, the payment server 102 selects one or more of the stored advertisements to be returned to the client device 10. In one or more embodiments, the advertisements selected to be returned may be the same for all client devices 10 and users or alternatively may be selected by the payment server based on certain characteristics of the client device 10/user requesting the advertisements (e.g., demographics, location, purchase or browsing history of the user, etc.).

In operation 904, the details of the advertisement are communicated to the client payment application 22 on the client device 10, where such details may include the product details, pricing information, offer details and/or a product identification code. The client payment application 22 is configured to cause the advertisement to be displayed to the user on the client device 10, where the client payment application 22 prompts the user to enter the product identification code in operation 905 in order to purchase the item being advertised. Upon entry of the product identification code, the purchase transaction is then completed as described in the various embodiments herein with the client payment application 22 communicating the product identification code and payment and user information 22 to the payment server 102 to complete the purchase transaction.

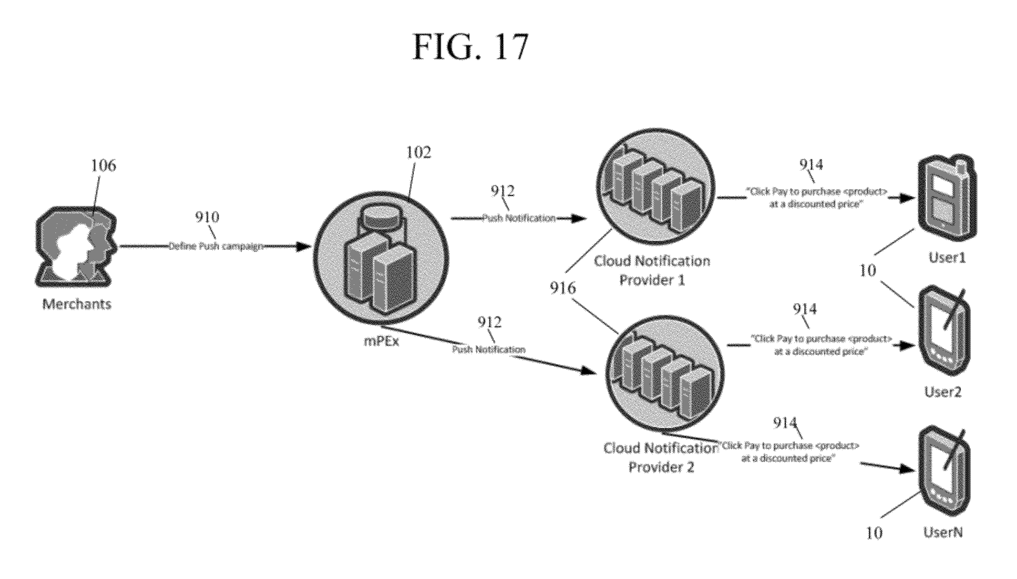

FIG. 17 illustrates a bill (or other type of invoice) payment implementation in which the present system, apparatus and method can be utilized in which goods or services are pushed from the merchant 106 to user for acceptance and payment via the client payment application 22 in accordance with one or more embodiments. In operation 910, a merchant 106 initiates a push campaign by communicating the details for at least one product or service to the payment server 102, where such details may include the product details, pricing information, offer details and/or a product identification code. In operation 912, the payment server 102 then provides a push notification to one or more cloud notification providers 916. The cloud notification providers are responsible with parsing or otherwise formatting the payment request in such a way that it is compatible with the client device 10 and/or the operating system of the client device 10 running the client payment application 22. The notification contains the details for the at least one product or service that are part of the push campaign of the merchant 106. The cloud notification providers 916 then communicate the product or service details that are part of the push campaign of the merchant 106 to one or more client devices 10 in operation 914, where the client payment application 22 will prompt users of the client devices 10 to enter the product identification code or select the offer through the client device 10 (e.g., “click to purchase product”) in order to purchase the item being advertised through the push campaign. Upon entry of the product identification code, the purchase transaction is then completed as described in the various embodiments herein with the client payment application 22 communicating the product identification code and payment and user information 22 to the payment server 102 to complete the purchase transaction.

In one or more embodiments, the client device 10 can be a wireless device that is connected to any type of wireless network or configured to communicate according to any appropriate wireless communication protocol. Examples of wireless networks include but are not limited to a Wireless LAN, Wireless WAN, Wireless PAN. The wireless network and wireless communication protocols can be offered by a telephony operator using GSM (with CSD, GPRS, EDGE, 3G, HSPA, LTE as data bearers), CDMA or WCDMA standards. The wireless network and wireless communication protocols can also be offered using short range wireless communication protocols such as WiFi (e.g., 802.11), Bluetooth, or the like.

In one or more embodiments, the client device 10 can be wired and therefore connected to a LAN or WAN using Ethernet or other type of cable. The network (e.g., network 104) may be the Internet (e.g., Web connection) or intranet, or a combination thereof. The network may further comprise a wired network or a wireless network or a combination thereof. For example, the components of the system may be selectively distributed over the Internet as well as maintained within an intranet of an organization and/or maintained within the client mobile computing device. Users are able to connect to components of the system through computing devices that are able connect through network, such as through their home computers, workstations, mobile phones or PDAs or other types of electronic computing devices.

In one or more embodiments, the system also includes a payment server 102 as well as a merchant server 106. In some embodiments, the merchant server 106 can be at least part of the same entity with the payment server 102. In one or more embodiments, the owner or user of the client device 10 is required to have a payment account (e.g., a physical or virtual credit or debit card), whose details are stored on the aforementioned client device 10. In one or more embodiments, the credit or debit card can have a magnetic stripe and/or a chip (ISO/IEC 7810 and ISO/IEC 7816) and can be attached to a financial account opened with a financial institution such as a bank or a credit union.

In one or more embodiments, another aspect of the present system, apparatus and method is the implementation of a mobile payment system comprising a payment server 102 or gateway and a merchant server, where the payment is realized through the means of a credit or debit card, physical of virtual, through the use of a dedicated application running on a device. In some cases in which physical product delivery is not required (for instance buying access into a service or buying digital content), the payment server 102 together with the merchant server 106 is also responsible of the actual delivery of the product or service.

Further aspects of the present system, apparatus and method include the capability of the payment server 102, upon receiving instructions from the merchant 106, to initiate a payment to a user or holder of a client device 10 that has the client payment application 22 installed thereon. In such circumstances, the payment server 102 will allow the merchant 106 to select from a predefined list of users (based on criteria entered by the merchant 106 and filters applied by the payment server 102), the merchant 106 will instruct the payment server 102 about the message to be sent to the user(s), the messages being related to purchases of the products offered by the merchant 106, purchases that need to be completed by the user

In one or more embodiments, the system described herein comprises a client payment application 22 installed on a client device 10 and a payment server 102 that processes the orders and sometimes (for specific products/services) fulfills the orders. In a simple two step transaction, the system allows the payment and the confirmation or even delivery (order fulfillment) of the goods and/or services. The present system, apparatus and method does not require the user, payment server 102 or merchant 106 to be in the same location, such that remote or mobile payments are enabled by the various embodiments described herein.

In one or more embodiments, the client payment application 22 and the a payment server 102 may be implemented in software, stored on a computer readable medium or computer readable storage medium, such as a memory of the respective device, where the memory may store computer readable instructions, e.g., program code, that can be executed by a processor or controller in a device (e.g., mobile device or personal computer) to carry out one or more of the techniques described herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor. In one or more embodiments, the actions and/or events of a method, algorithm or module may reside as one or any combination or set of codes and/or instructions on a computer readable medium or machine readable medium, which may be incorporated into a computer program product.

In one or more embodiments, the payment server 102 referred to herein refers to any computer or device with a processor capable of executing logic or coded instructions, and could be a server, personal computer, set top box, smart phone, pad computer or media device, to name a few such devices. The internal architecture of the payment server 102 may include one or more processors (or CPUs), which interface with at least one computer bus. Also interfacing with the computer bus are persistent storage medium/media, a network interface, a memory, e.g., random access memory (RAM), run-time transient memory, read only memory (ROM), etc., media disk drive interface as an interface for a drive that can read and/or write to media including removable media such as floppy, CD ROM, DVD, etc. media, a display interface as interface for a monitor or other display device, at least one input interface (e.g., keyboard interface, mouse or other pointing device interface, etc.), and miscellaneous other interfaces not shown individually, such as parallel and serial port interfaces, a universal serial bus (USB) interface, and the like. The memory of the payment server 102 interfaces with the computer bus so as to provide information stored in memory to the one or more processors during execution of software programs such as an operating system, application programs, device drivers, and software modules that comprise program code, processor-executable instructions and/or computer executable process steps, incorporating the functionality of the payment server described herein, e.g., one or more of process flows described herein. The at lease one processor loads processor-executable process steps from storage, e.g., memory, storage medium/media, removable media drive, and/or other storage device, where the processor can then execute the stored process steps in order to execute the loaded processor-executable process steps. Stored data, e.g., data stored by a storage device, can be accessed by the processor during the execution of processor-executable process steps. Persistent storage medium/media is a computer readable storage medium(s) that can be used to store software and data, e.g., an operating system and one or more application programs, device drivers, and/or program modules and data files used to implement one or more embodiments of the present disclosure.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client device or payment server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which may be accorded the broadest interpretation so as to encompass all such modifications and similar structures. The present disclosure includes any and all embodiments of the following claims.

1. A system enabling mobile payment and order fulfillment, the system comprising:
a client payment application installed on a mobile client device configured to securely store user-related information associated with at least one payment account on the client device; and
a payment server configured to communicate with the client payment application and process payments through the at least one payment account and authorize purchase transactions,
wherein the client payment application is further configured to communicate the user-related information to the payment server along with a identification code that identifies a purchase transaction to be made by the payment server,
wherein the payment server is further configured to obtain details for the purchase transaction using the identification code received from the client payment application and to process payment for the purchase to be made using the user-related information received from the client payment application.

2. The system of claim 1, wherein the payment server is further configured to provide notification to a merchant of a completed purchase after processing payment for the purchase.

3. The system of claim 1, wherein the payment server is further configured to:
communicate with a merchant to receive details regarding a purchase transaction;
generate an identification code associated with the purchase transaction; and
communicate the details of the purchase transaction and the associated identification code to the client payment application.

4. The system of claim 3, wherein the client payment application is further configured to:
cause the details of the purchase transaction and the associated identification code received from the payment server to be displayed on the client device;
receive an indication from a user of the client device to complete the purchase transaction; and
communicate the user-related information and identification code to the payment server to complete the purchase transaction.

5. The system of claim 1, wherein the client payment application is further configured to require a security code to be input upon activation of the client payment application in order to authorize usage of the client payment application.

6. The system of claim 5, wherein the client payment application is further configured to collect the user-related information associated with at least one payment account upon initial activation of the client payment application and securely store the collected user-related information on the client device.

7. A method for enabling mobile payments and order fulfillments, the method comprising:
securely storing user-related information associated with at least one payment account on a mobile client device using a client payment application installed on the mobile client device;
receiving an identification code on the mobile client device that identifies a purchase transaction;
communicating a payment request message from the mobile client device to a payment server, wherein the payment request message includes the user-related information associated with at least one payment account previously stored on the mobile client device and an identification code that identifies a purchase transaction; and
obtaining details for the purchase transaction at the payment server using the identification code received from the client payment application; and
processing payment at the payment server for the purchase to be made using the user-related information received from the client payment application and the details associated with the identification code.

8. The method of claim 7, further comprising providing notification to a merchant of a completed purchase after processing payment for the purchase.

9. The method of claim 7, further comprising:
receiving details regarding a purchase transaction at the payment server from the merchant;
generating an identification code associated with the purchase transaction; and
communicating the details of the purchase transaction and the associated identification code from the payment server to the client payment application.

10. The method of claim 9, further comprising:
causing the details of the purchase transaction and the associated identification code received from the payment server to be displayed on the client device;
receiving an indication from a user of the client device to complete the purchase transaction; and
communicating the user-related information and identification code from the client payment application to the payment server to complete the purchase transaction.

11. The method of claim 7, further comprising requiring a security code to be input upon activation of the client payment application in order to authorize usage of the client payment application.

12. The method of claim 7, further comprising collecting the user-related information associated with at least one payment account upon initial activation of the client payment application and securely storing the collected user-related information on the client device.

13. A computer program product comprising a non-transitory computer-readable medium having instructions, the instructions being operable to enable a mobile client device, when executed by a processor, to perform a method for enabling mobile payments and order fulfillments, the method comprising
securely storing user-related information associated with at least one payment account on a mobile client device using a client payment application installed on the mobile client device;
receiving an identification code on the mobile client device that identifies a purchase transaction;
communicating a payment request message from the mobile client device to a payment server for payment completion, wherein the payment request message includes the user-related information associated with at least one payment account previously stored on the mobile client device and an identification code that identifies a purchase transaction.

14. The computer program product of claim 13, wherein the method further comprises:
receiving details of the purchase transaction and the associated identification code from the payment server;
causing the details of the purchase transaction and the associated identification code received from the payment server to be displayed on the client device;
receiving an indication from a user of the client device to complete the purchase transaction; and
communicating the user-related information and identification code from the client payment application to the payment server to complete the purchase transaction.

15. The computer program product of claim 13, wherein the method further comprises requiring a security code to be input upon activation of the client payment application in order to authorize usage of the client payment application.

16. The computer program product of claim 13, wherein the method further comprises collecting the user-related information associated with at least one payment account upon initial activation of the client payment application and securely storing the collected user-related information on the client device.

17. A computer program product comprising a non-transitory computer-readable medium having instructions, the instructions being operable to enable a payment server to execute a purchase transaction based on instructions received from mobile client device, when executed by a processor on the payment server, to perform a method for enabling mobile payments and order fulfillments, the method comprising
receiving a payment request message from a mobile client device that includes user-related information associated with at least one payment account and an identification code that identifies a purchase transaction;
obtaining details for the purchase transaction at the payment server using the identification code received from the client payment application; and
processing payment at the payment server for the purchase to be made using the user-related information received from the client payment application and the details associated with the identification code.

18. The computer program product of claim 17, the method further comprising providing notification to a merchant of a completed purchase after processing payment for the purchase.

19. The computer program product of claim 17, the method further comprising:
receiving details regarding a purchase transaction at the payment server from the merchant;
generating an identification code associated with the purchase transaction; and
communicating the details of the purchase transaction and the associated identification code from the payment server to a client payment application on the mobile client device.
